(19) United States
(12) Patent Application Publication
(10) Pub. No.: US 2016/0174253 A1
(43) Pub. Date: Jun. 16, 2016

(54) METHOD OF CHANNEL ACCESS CONTROL IN WIRELESS LOCAL AREA NETWORKS

(71) Applicants: Jianhan LIU, San Jose, CA (US); James June-Ming WANG, San Marino, CA (US); Thomas Edward PARE, JR., Mountain View, CA (US); Yung-Ping HSU, Taipei City (TW); MEDIATEK SINGAPORE PTE. LTD., Solaris (SG)

(72) Inventors: Jianhan Liu, San Jose, CA (US); James June-Ming Wang, San Marino, CA (US); Thomas Edward Pare, JR., Mountain View, CA (US); Yung-Ping Hsu, Taipei City (TW)

(21) Appl. No.: 14/903,596

(22) PCT Filed: Jul. 13, 2014
(86) PCT No.: PCT/US14/46452

§ 371 Date: Jan. 8, 2016

Related U.S. Application Data
(60) Provisional application No. 61/845,694, filed on Jul. 12, 2013.

(51) Int. Cl. H04W 74/00; H04W 24/08

(52) U.S. Cl. CPC H04W 74/002; H04W 24/08

(57) ABSTRACT

A method to improve the area throughput of dense wireless local area networks (WLAN) by channel access control is proposed. The method allows an access point to obtain information of a plurality of stations within the wireless network. The access point classifies the plurality of stations into at least one group of stations and assigns a group identification (ID) according to the obtained information. The group ID and channel access control parameters are sent to the stations that are classified into the certain group. The stations in each of the group use the received channel access control parameters to communicate with the access point.

### CROSS REFERENCE TO RELATED APPLICATIONS

This application claims priority under 35 U.S.C. §119 from U.S. Provisional Application No. 61/845,694, entitled “Methods of Location/Range Based Channel Access Control in Wireless Local Area Networks,” filed on Jul. 12, 2013, the subject matter of which is incorporated herein by reference.

### TECHNICAL FIELD

The disclosed embodiments relate generally to wireless network communications, and, more particularly, to channel access control methods in wireless local area networks.

### BACKGROUND

IEEE 802.11 is a set of media access control (MAC) and physical layer (PHY) specification for implementing wireless local area network (WLAN) communication, or Wi-Fi, in the unlicensed (2.4, 3.6, 5, and 60 GHz) frequency bands. The standards and amendments provide the basis for wireless network products using the Wi-Fi frequency bands.

However, the average throughput that each station (STA) can achieve in a wireless network drops significantly when the network becomes dense, i.e., when there are a lot of stations serviced by only a few access points (AP) within a given area. FIG. 1 shows the average throughput per STA in a 400 square meter region. One can see that the average throughput per STA decreases at least inversely proportional to the density of the WLAN. This is because the chances of collisions of transmission signals increase. Therefore, the STA that transmits the collided signals has to back-off a certain period time and tries to re-transmit the signal again. If the collision happens again, the STA has to repeat the back-off step and tries again. This will dramatically reduce the overall throughput within the network.

Moreover, consider a WLAN comprised of a few overlapped basic service sets (OBSSs) 210, 220, 230 as shown in FIG. 2. In this network, three APs, AP1 211, AP2 221, AP3 231 operate on the same frequency band or at least have one frequency band overlapped. Each AP is associated with a number of STAs. Each AP and STA can control its transmitter power such that the transmission range can be controlled. For example, when AP1 211 communicates with STA1_2 213, both AP1 211 and STA1_2 213 transmit signals with lower power such that the transmitted signals only reach in the area circled by a dash line. Under this circumstance, AP2 221 and AP3 231 are able to communicate with its own short-ranged STAs at the same time, respectively. Therefore, the total throughput of the overall network increases.

However, when AP1 211 communicates with STA1_3 214, both AP1 211 and STA1_3 214 need to transmit signals with higher power since the signals have to travel a much longer range. During the communication between AP1 211 and STA1_3 214, AP2 221 and AP3 231 cannot communicate with any STAs due to collisions. In this case, the total throughput is low because simultaneous communications in multiple OBSSs are not possible.

Spatial reuse is a method proposed to improve the network throughput. If the STA within the overlapped area has knowledge of the frequencies used by the different APs, the STA can use beamforming to communicate with the AP it associates with to prevent the collision with the other AP. However, this requires the STA to have the beamforming capability which is not included in legacy devices.

Another method is to control the transmission power by the STA and the AP to ensure the transmission quality. However, the services to the STAs located at the edge of the BSS are sacrificed.

To enhance the average throughput per STA in a dense WLAN, the total throughput of the whole WLAN needs to be enhanced. Hence, there's a need to provide a method to control channel access in wireless networks.

### SUMMARY

A method to improve the area throughput of dense wireless local area networks (WLAN) by channel access control is proposed.

The method allows an access point to obtain information of a plurality of stations within the wireless network. The access point classifies the plurality of stations into at least one group of stations and assigns a group identification (ID) according to the obtained information. The group ID and channel access control parameters are sent to the stations that are classified into the certain group. The stations in each of the group use the received channel access control parameters to communicate with the access point.

In one embodiment, the obtained information is a range information from the stations, an overlapped basic service set (OBSS) information from another access point, or an interference map of distribution and traffic load of surrounding stations. The interference map can be dynamic.

Other embodiments and advantages are described in the detailed description below. This summary does not purport to define the invention. The invention is defined by the claims.

### BRIEF DESCRIPTION OF THE DRAWINGS

FIG. 1 illustrates an average throughput per station in a wireless local area network.

FIG. 2 illustrates a network with multiple OBSS.

FIG. 3 is a flow chart of channel access control accordance with one novel aspect.

FIG. 4 is a flow chart of channel access control accordance with one novel aspect.

FIG. 5 illustrates a frame carrying channel access information element accordance with one novel aspect.

FIG. 6 illustrates a frame carrying possible channel access parameters accordance with one novel aspect.

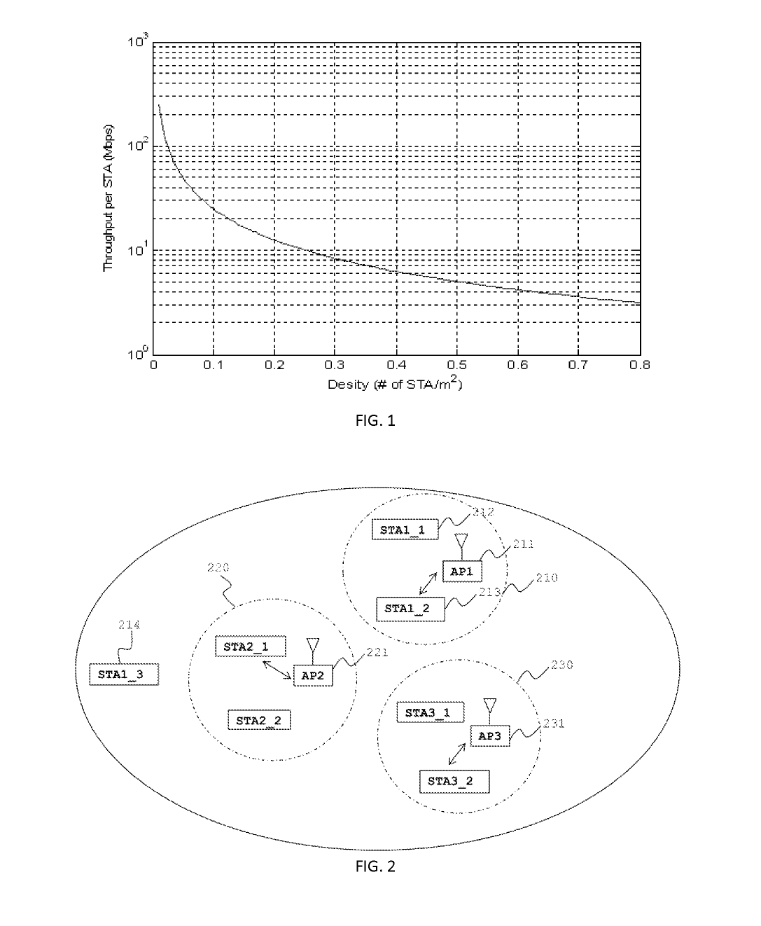

### DETAILED DESCRIPTION

Reference will now be made in detail to some embodiments of the invention, examples of which are illustrated in the accompanying drawings.

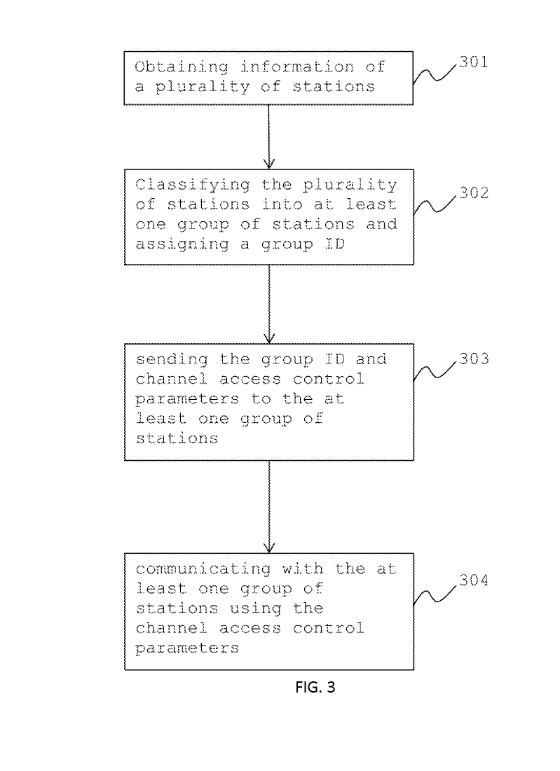

FIG. 3 is a flow chart illustrating a method for channel access control. In Step 301, an access point (AP) obtains information from the plurality of stations within the wireless network. The information can be range or location information. The range/location information can be measured by the AP or be obtained via feedback from the STAs. Ranging/location information can be done through measuring the time of arrival and/or the angle of arrival from the STAs to the AP. In another example, the methods provided in IEEE 802.11v specification can also be used to collect such range/location information. In a further example, the information can be a location information obtained from the packets received by the AP. If a STA receives a location information from other STAs or AP, the STA can also forwards the location information to the AP.

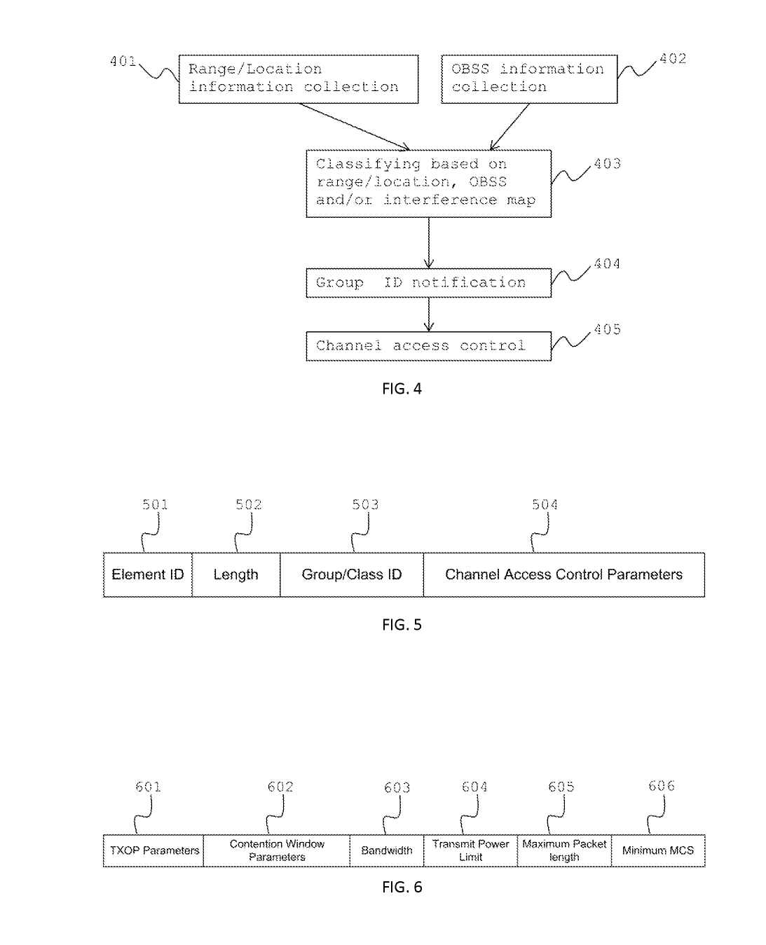

In addition to the range/location information, AP can also obtain OBSS information by receiving beacons from other OBSSs or by information inquiring from the APs in OBSSs, such as the flow chart shown in FIG. 4. OBSS information may include the presentence of OBSSs, OBSS load and locations of OBSSs, etc. OBSS load information can be obtained by checking the OBSS load information element (IE) sent by OBSS APs.

In another example, the information can be interference map that is obtained based on the information of OBSSs and distribution and traffic load of surrounding STAs. The interference map can be dynamic to reflect actual situation.

In step 302, the plurality of stations are classified into at least one group according to the information obtained in step 301, such as range/location and/or interference map of each STA, or OBSS information and possibly interference map from OBSSs. A group identification (ID) is then assigned to each of the group.

When the classification is done, the AP notifies the associated STA the group ID it belongs to. Therefore, the STAs within the same group receive the same group ID. The notification can be done by sending a group ID management frame. The notification can also be done by respectively sending notice to each STA or by simultaneously notify the STAs within the same group. An example of the applicable group ID management frame is defined in IEEE 802.11ac standard.

The group ID management frame may also include the channel access control information. Therefore, the STAs receiving the same group ID may also receive the same channel access control information, while the STAs with different group ID may receive different channel access control information. The STAs that receive the group ID Management frame are required to send feedback frames to confirm the reception of the frame correctly. Also, the STAs can at the same time confirm whether the channel access control parameters assigned by the AP are accepted. According to another example, the channel access control information can be sent to each group of STAs in a frame other than the group ID management frame.

The channel access control information can be used to do channel access control in the contention-based channel access schemes. In this scenario, AP sends each grouped STAs the specific channel access parameters. An example is that AP sends out a beacon or another management frames that contain a channel access control information element (IE) as shown in FIG. 5.

The channel access control parameters are used to restrict the channel access for the different groups of STAs. FIG. 6 illustrates an example of the frame that carries possible channel access control parameters. In one embodiment, channel access control parameters can include part or all of the parameters, such as channel access time, transmit opportunity (TXOP) parameters, contention window parameters, bandwidth, transmit power limit, maximum packet length and minimum MCS, or any other applicable parameters. Some examples of the parameters are further described below.

For the contention window parameters, it can include aCWmin and aCWmax, which respectively specify the value of the minimum size of the contention window for the STAs in this group, the value of the maximum size of the contention window for the STAs in this.

For Transmission opportunities parameters (TXOP parameters), it can be a TXOP limit as defined in IEEE 802.11 standard. If the AP received a TXOP request from a STA, AP can choose to reject the request if the required TXOP exceeds the TXOP limit for that group.

Bandwidth is the frequency band that the STAs in the group can use. For example, in an 80 MHz BSS, a group of STAs can only be allowed to use 40 MHz due to interference map.

Transmit power limit puts a limit on the maximum power the STAs in the group can transmit.

Channel access control parameters can also contain the maximum packet length and the minimum MCS that the STAs in the group/class can use.

Channel access control can also be used in a hybrid controlled channel access schemes or point coordinated schemes. In this scenario, AP allocates a specific time period for each group. For example, the group of STAs with long range transmissions or may affects more OBSSs is allocated with short time period, while and the group whose transmissions covers short range or affects less OBSSs is allocated with a long time period.

Now referring to FIG. 3 again. In step 304, the AP and the groups of the STAs use the channel access control parameters to communicate with each other. Since different groups of STAs are assigned with different channel access control parameters, the overall throughput can be improved without sacrificing the STAs at the edge of each BSS.

In case that certain STA refuses to accept the assigned channel access control parameters, the AP may reject the service to that certain STA. Further in another example, the AP may dynamically change the classification of the STAs according to the actual channel condition or the information from the STAs.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
obtaining information of a plurality of stations by an access point within a wireless network;
classifying the plurality of stations into at least one group of stations and assigning a group identification (ID) according to the information;
sending the group ID and channel access control parameters to the at least one group of stations;
communicating with the at least one group of stations using the channel access control parameters.

2. The method of claim 1, wherein the information is a range information obtained by feedback from the plurality of stations to the access point.

3. The method of claim 1, wherein the information is a range information obtained by measuring a time of arrival or an angle of arrival from the plurality of station to the access point.

4. The method of claim 1, wherein the information is an overlapped basic service set (OBSS) information from another access point.

5. The method of claim 4, wherein the OBSS information comprises presences of OBSS, OBSS load, or locations of OBSS.

6. The method of claim 4, wherein the OBSS information is obtained by checking an information element.

7. The method of claim 1, wherein the information is a location information obtained from received packets.

8. The method of claim 1, wherein the information is an interference map of distribution and traffic load of the plurality of stations.

9. The method of claim 8, wherein the interference map is dynamically updated.

10. The method of claim 1, wherein the group ID and the channel access control parameters are sent in a group management frame.

11. The method of claim 1, wherein the group ID is sent in a beacon, and the channel access control parameters are sent in a separate frame.

12. The method of claim 1, wherein the channel access control parameters comprise, transmit opportunity, contention window parameters, bandwidth, transit power limit, maximum packet length, and/or minimum modulation and coding scheme (MCS).

13. The method of claim 1, wherein the channel access control parameters sent to a group of stations that is farther to the access point limit the group of stations to communicate with the access point.
